(19) United States
(12) Patent Application Publication
(10) Pub. No.: US 2006/0003891 A1
(43) Pub. Date: Jan. 5, 2006

(54) Spent FCC catalyst based coagulating and flocculating agent and method for making it

(76) Inventors: Tao Zhang, FortMcMurray (CA); Peisheng Zhang, Shijiazhuang (CN); Yin Zhang, Shijiazhuang (CN)

Correspondence Address: Tao Zhang, 188#, J.W. Mann Drive, FortMcMurray, AB, T9H 5G7, CA

(21) Appl. No.: 11/140,302

(22) Filed: May 31, 2005

Related U.S. Application Data
(60) Provisional application No. 60/583,635, filed on Jun. 30, 2004.

(51) Int. Cl. B01J 38/00; B01J 21/00; B01J 23/745; C02F 1/52

(52) U.S. Cl. 502/514; 210/728

(57) ABSTRACT

The proposed coagulating and flocculating agent and the method for making it provide an efficient and economically attractive means for cleaning liquids, particularly water, and waste water and sludge. The spent FCC catalyst based coagulating and flocculating agent is a mineral material comprising polymeric aluminum chloride (PAC) [Al₂(OH)ₙCl₆₋ₙ]ₘ, n<5, m<10, hydrated ferric chloride [FeCl₃·6H₂O] and extracted spent FCC catalyst. Furthermore, polymeric aluminum chloride and hydrated ferric chloride are evenly distributed inside the inter pores and outside surface of spent FCC catalyst, this unique feature of the proposed coagulating and flocculating agent leads to an excellent water treatment efficiency. In addition, the method of making it eventually convert spent FCC catalyst, currently being treated as semi-hazardous wastes produced by FCC process, into an environmental friendly new product without any byproduct in the making process.

### CROSS-REFERENCE TO RELATED APPLICATIONS

This application is claiming the benefit of the provisional patent application No. 60/583,635, filed Jun. 30, 2004 and titled as “Spent FCC catalyst based coagulating and flocculating agent and method for making it”.

### REFERENCES CITED

U.S. patent documents

| | | | |
|---|---|---|---|
| 4,024,087 | 5/1977 | Lainer et al. | 252/179 |
| 4,069,299 | 1/1978 | Hodgson | 423/462 |
| 4,435,308 | 3/1984 | Thomas et al. | 252/181 |
| 4,795,585 | 1/1989 | Becker | 210/723 |
| 5,110,363 | 5/1992 | Clarker et al. | 210/716 |
| 5,830,388 | 11/1998 | Kigel et al. | 252/175 |

Other publications
Chem. Abstr., vol. 109, No. 16, Oct. 17, 1998 (Columbus Ohio, USA) p. 145, column 2, the abstract No. 109: 131675, ZAKHAROV V.I. et al., ‘Manufacture of aluminum-containing coagulant’, SU 1399268-A2 880530 (Russ).

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

The present invention relates to creation of new and useful spent Fluidized Catalytic Cracking (FCC) catalyst based coagulating and flocculating agent that can be used in water and/or waste water, and/or sludge treatment process, and/or other contaminated liquids resulting from a variety of municipal discharges and industrial process effluents, as well as to separate suspended and colloidal particles from liquids in industrial manufacturing processes. The areas of treatment to which the new coagulating and flocculating agent may be applied are practically limitless. For exemplary purposes only a partial list of some of them includes but is not limited to: (1) potable surface water, ground water, and industrial water; (2) sewage; (3) sludge and elutriate from sludge; (4) filter backwash water; (5) industrial waste water from petroleum processing and petroleum products manufacturing and processing operations; (6) waste water from chemical, cosmetics, flavors, soap, fragrances, dyes and pharmaceutical product manufacturing and processing operations; (7) waste water from ore concentration and coal preparation operations; (8) water and waste water related to nuclear power plants; (9) waste water from metallurgical and other metal processing technologies, particularly recycling water, exhaust control wet scrubbers, flue gas absorption systems, etc.; (10) electroplating process waste streams; (11) agricultural operations; (12) soil remediation and treatment; (13) waste water from tanning operations; (14) waste water from mining operations; (15) oil, grease and fat contaminated wastes; (16) waste water from meat, corn starch, dairy products, beverages, and other food processing operations, (17) textile, leather processing, and paper mill factories waste streams, etc.

2. Description of Prior Art

The processes of coagulation and flocculation are employed to separate suspended solids from water whenever their natural subsidence rates are too slow to provide effective clarification. Water clarification, lime softening, sludge thickening, and dewatering depend on correct application of coagulating and flocculating agent for their success.

Major processes, equipments and reagents commonly used for water and wastewater treatment has been developed for so called traditional contaminants. The rapid development of industries has lead to more and more extensive water use and discharges of insufficiently treated or even not treated waste water in the natural water bodies contaminated with non-traditional impurities which cannot be removed with traditional way. On the other hand, more and more stringent waste discharge government regulations put tremendous pressure on industry to invest huge amount of capital in the water and wastewater treatment plants. Eventually, this will be a substantial burden adversely impacting industrial development.

Among various coagulants and flocculants, such conventional coagulants as aluminum and iron salts as well as their combinations are most widely used. To increase phase separation process efficiency, some flocculants such as activated silica acid and polyacrylamide have been added to the coagulants.

There have been the common disadvantages of conventionally used coagulants such as aluminum sulfate, aluminum chloride, sodium aluminate, ferric chloride, ferric sulfate, ferrochlorosulfate, etc. they are characterized by high level of swelling and retention of large volume of water, they are not entirely stable and tend to produce hydroxide precipitate which considerably reduce the flocculating and coagulating efficiency. These coagulants and flocculants do not perform well in combination with other chemical reagents of water and wastewater since their efficiency depends on pH, chemical components (natural and added during treatment) of water, and temperature. Additionally, the production of the conventional coagulants is relatively complicated and expensive, requires expensive reactant contains aluminum element. These disadvantages have a pronounced effect on the cost increasing of the water, waste water and sludge treatment processes.

It is known that from economic point of view, hydrochloric acid is more preferable than sulfuric acid for making aluminum based coagulants and flocculants.

U.S. Pat. No. 4,435,308 describes an aluminum hydroxychloride composition characterized by the presence of SO₄²⁻ anions along with an ion of an organic acid, particularly citric acid as a flocculation-enhancing additive. A draw back of this coagulating and flocculating agent is that the components the agent is made from are rather expensive, which would restrict wide use of the agent.

U.S. Pat. No. 4,069,299 describes a hydroxyaluminum chloride or sulfate polymer made of urea and aluminum chloride or sulfate. A practical drawback of this process is the use of urea is expensive and is subject to limited practical availability.

U.S. Pat. No. 4,795,585 describes that polyvinyl alcohol (PVA) can be effectively utilized as a floc conditioner during the formation of polyaluminum chloride. A disadvantage of this process is that PVA is an anionic polymer that lowers a positive charge of aluminum hydroxide floc and may result in a overdosing of coagulating composition to treat water having high color and low turbidity. Its application, therefore, is being limited.

U.S. Pat. No. 4,024, 087 describes a method of preparing a coagulant from alunite by roasting it at the temperatures as high as 520° C.-620° C. The treating with H₂SO₄ at 80° C.-100° C. Followed by leaching and separating the final product. The method requires precise dosage of the components and cooling the intermediate products during the process. A downside of the method is its complexity and difficulties to maintain at very high temperatures.

U.S. Pat. No. 5,110,363 describes a non-toxic composition, and method, for clarification of raw sugar-containing juices. A composition consists of aluminum chloride hydroxide, lime and actived bentonite and preferably also of polymeric flocculating agent. However, it is a just a mixture of commercialized products and the application field is limited too.

U.S. Pat. No. 5,830,388 describes a coagulating and flocculating agent based on aluminum pentahydroxychloride, which has its activity enhanced with an inorganic or organic flocculation enhancing additive such as natural or synthetic molecular sieve and/or cationic, anionic and non-ionic powdered, emulsified or liquid polyacrylamide. There are 2 drawbacks of this method. Firstly, it produces the byproduct called silicon oxide containing sludge during the production process, which is an environment hazard and hard to deal with. Secondly, the proportion of the zeolite is being limited due to the limited resources and expensive cost. Due to these weaknesses, its application is not practical.

### BRIEF DESCRIPTION OF THE INVENTION

In petroleum refining industry, fluidized catalytic cracking (FCC) units consume substantial amount of catalyst. FCC catalyst that is synthetic aluminum silicate containing large amount of molecular sieve. Upon to different technical resources, normal content of aluminum oxide in FCC catalyst is 40-45% (weight) and the molecular sieve content is more than 40% (weight). It is noted that the nature of FCC unit operation dictates that a fraction of the catalyst inventory needs to be replaced with fresh catalyst on a continuous basis. This unloaded catalyst is called spent FCC catalyst, which is semi-hazardous waste produced by FCC process and so far it presents as a challenge to industry to find a way to reuse it economically and environmental friendly.

The typical features of spent FCC catalyst are illustrated as follows:
(1). High aluminum content: it contents aluminum oxide not less than 40% weight. Average level is 40-50%.
(2). High specific surface area: its range is between 400˜550 m²/g.
(3). High pore volume: it typically ranges from 0.6 to 0.8 ml/g.
(4). High bulk specific gravity: 0.5-0.8 g/ml are most common range.
(6). Evenly distributed particle size: the catalyst particle size falls into between 0-120 micron. The average particle diameter is 60 to 80 micron.

The above unique features of spent FCC catalyst imply some excellent potential for making a new type of coagulating and flocculating agent such as follows:

Firstly, high aluminum content provides extremely low cost, stable reactant, which otherwise would cost much more to produce polymeric aluminum chloride (PAC).

Secondly, high specific surface area and pore volume allows the produced PAC to be absorbed evenly and adhered inside the spent FCC molecular sieve pores, which serve as adsorption centers during water treatment process to draw suspended solids and colloids closely surrounding the pores to form heavy and large size flocs, this will dramatically enhanced the coagulating and flocculating efficiency.

Thirdly, high specific gravity of spent FCC catalyst will help to reduce the sedimentation time after the large flocs formed.

Lastly, comparing with the conventional agent making methods, evenly distributed particle size of spent FCC catalyst makes it possible to participate the reaction directly without any crush or grounding steps that are necessary if some kinds of aluminum ores were selected. This reduces the production cost dramatically. Additionally, this will also speed up the reaction time by allowing direct contact between reactants.

It is known that multiple metals based coagulating and flocculating agents such as aluminum, iron, magnesium, often show better effects than single metal-based agent. Another particular consideration of conducting iron into the reaction in this present invention is that it can helps to control the extracting level of aluminum from the molecular sieve structure of the spent FCC catalyst so that these adsorption centers can be protected without overly structure damage.

It is an object of the present invention to provide a coagulating and flocculating agent and a method for making it utilizing spent FCC catalyst as aluminum providing source, which could be inexpensive and practically available.

It is an another object to achieve much higher coagulating and flocculating efficiency than the traditional coagulating and flocculating by introducing a new floc-forming driving force: the unique internal structure of the inside of the molecular sieve that is delicately provided by spent FCC catalyst.

It is also an object to conduct iron into our agent to enhance the coagulating and flocculating effect.

Additionally, to eliminate any byproduct in the making process of coagulating and flocculating agent is one of the objects as well.

It is a further objective to provide a coagulating and flocculating agent and a method for making it with desirable low operating temperatures of the flocculating agent production process.

It is a further goal to provide a coagulating and flocculating agent and a method for making it in relatively short agent producing process time.

It is a further objective to provide a coagulating and flocculating agent and a method for making it, which minimizes and possibly avoids presence of residual metals in the treated effluents.

The proposed coagulating and flocculating agent and the method for making it provide an efficient and economically effective means for treating liquids, particularly water, and waste water and sludge.

In addition, it will eventually convert spent FCC catalyst, currently being treated as semi-hazardous waste produced by FCC process, into an environmental friendly new product.

The spent FCC catalyst based coagulating and flocculating agent is a mineral material comprising polymeric aluminum chloride (PAC) [Al₂ (OH)ₙCl₆₋ₙ]ₘ, n<5, m<10, hydrated ferric chloride [FeCl₃·6H₂O ] and extracted spent FCC catalyst. Furthermore, polymeric aluminum chloride and hydrated ferric chloride are evenly distributed inside the inter pores and outside surface of spent FCC catalyst.

### BRIEF DESCRIPTION OF THE DRAWINGS

FIG. 1 is a schematic drawing of the spent FCC catalyst based coagulating and flocculating agent production process made from spent FCC catalyst, iron waste dust and hydrochloric acid.

FIG. 2 is a chart, which illustrates the results of comparative testing of water treatment using aluminum sulfate, polymeric aluminum chloride and the spent FCC catalyst based coagulating and flocculating agent of the proposed intention.

FIG. 3 is a chart that indicates the results of comparative testing of reagent dosage for treating water using aluminum sulfate, and the spent FCC catalyst based coagulating and flocculating agent of the proposed intention.

### DETAILED DESCRIPTION OF THE INVENTION

The inventive coagulating and flocculating agent and a method for making it is a process generally described by one of the following reactions wherein Al₂O₃ in spent FCC catalyst and iron waste dust are the aluminum and iron providing sources correspondingly.
Al₂O₃+HCl+2H₂O→Al₂(OH)₅Cl

(Note: in general, the molecular formula of polymeric aluminum chloride is [Al2(OH)nCl6-n]m, n<5, m<10. Here, n=1 and m=l are chosen for demonstration purpose only)
Fe+3HCl+6H₂O→FeCl₃·6H₂O+3H⁺

The dosage of hydrochloric acid for extracting aluminum oxide is within the range of about 23-29%, preferably about 25-27%. Lower HCl concentration can cause longer reaction time and higher water content in the final product. Higher concentration can cause overly extracting aluminum from molecular sieve and lead to the reduction of final product quality.

The range of process temperature is about 90-110° C., the process pressure is at or slight above the atmospheric pressure. And the process residence time is about 20-35 minutes.

Following the process of polymeric aluminum chloride and hydrated ferric chloride formation, sodium hydroxide and sodium carbonate are added to fine tune the product PH to the optimum range of 3 to 4.

The pulp material then is sprayed into the rotary drier with the temperature controlled at 110-140° C. to form the final powder product.

Preferably, the above coagulating and flocculating agent is used for water and waste water clarification.

The following example and tests illustrate the invention.

### EXAMPLE 1

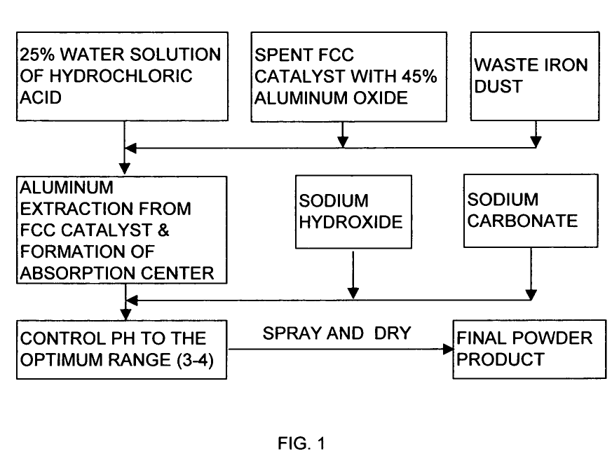

Spent FCC catalyst based coagulation and flocculation agent containing polymeric aluminum chloride, hydrated ferric chloride and FCC catalyst molecular sieve is prepared with the 3-liter bench-scale kettle reactor and spray drier equipment. A schematic drawing of the flow diagram of the process is shown in FIG. 1, with spent FCC catalyst as aluminum providing source herein, the main properties of the spent FCC catalyst are such as follows: Al₂O₃ content is 45%, molecular sieve content is 40%, specific surface area is 410 m²/g, the pore volume is around 0.64 ml/g and the bulk specific gravity is 0.58 g/ml. The average particle size is 80 micron. In the beginning, 1 liter of 25% solution of hydrochloric is introduced in the kettle reactor at 20° C. and the atmospheric pressure, then, the center mixer is starting to rotate at 40-50 rpm. At the same time, 1 kg of spent FCC catalyst and 10 grams iron waste dust are gradually introduced and the temperature is evaluated up to around 98° C. The catalyst brake-up is noticed and after approximately 25 minutes, the pulp-like material formed without any further reaction. Then approximated 10 grams each of sodium hydroxide and sodium carbonate are introduced into the kettle reactor to achieve the desired optimum pH within the range of 3-4. After this step is finished, the pulp-like material is sprayed into the spray drier to form the final solid powder product, which is used for the comparative testing its effects and properties.

### Test 1

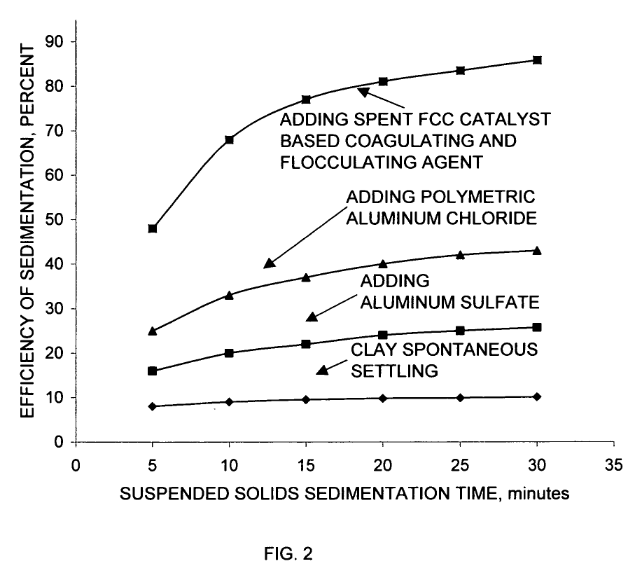

A standard jar test method is used for comparative testing of suspended solids sedimentation process using commercialized aluminum sulfate; commercialized PAC and the proposed spent FCC catalyst based coagulating and flocculating agent. Artificial raw water is prepared with the 10 mg/L clay suspension. FIG. 2 graphically illustrates the efficiency of suspended vs. various reagents. The dosage of each alternative regent is 20 mg/L. it is clear that the efficiency of water sedimentation using the spent FCC catalyst based coagulating and flocculating agent of the present invention is about 50 to 55% higher than the one using commercialized PAC.

### Test 2

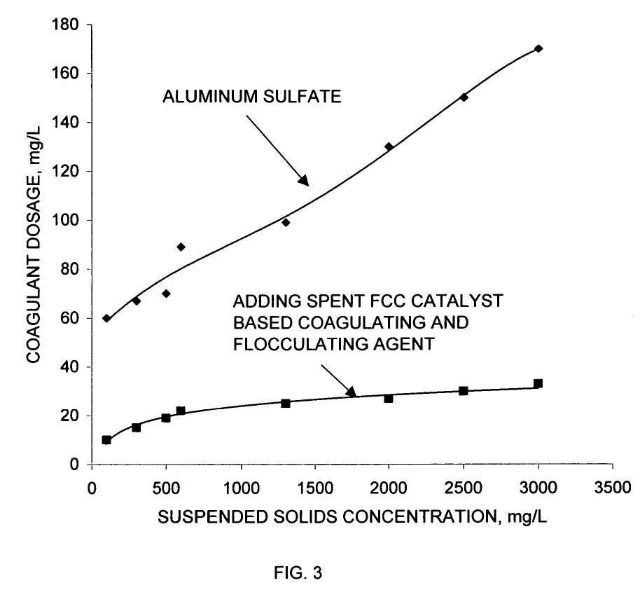

A standard test of the sedimentation process kinetics using standard 1 liter cylinders is taken to compare the coagulant dosage required to obtain 90% efficiency for the 2 hour period of time of sedimentation with 2 reagents: commercialized aluminum sulfate and the proposed spent FCC catalyst based coagulating and flocculating agent. The dosages are calculated by dehydrated material. FIG. 3 is a chart illustrates the results of this test as coagulant dosage vs. suspended solids concentration. It is clear that the required dosage of the proposed spent FCC catalyst based coagulant and flocculation agent is 3-5 times lower than aluminum sulfate.

The example and tests are shown with the purpose of illustration. Alternatives and modifications will be understood by those skilled in the art.

We claim:

1. A method for making a coagulating and flocculating agent that is a mineral material essentially comprising polymeric aluminum chloride (PAC, [Al₂(OH)ₙCl₆₋ₙ]ₘ, n<5, m<10), hydrated ferric chloride ([FeCl₃·6H₂O]) and extracted spent FCC catalyst in which polymeric aluminum chloride and hydrated ferric chloride are evenly distributed inside the inter pores and outside surface of spent FCC catalysts, wherein said aluminum chloride and hydrated ferric chloride are produced by treating spent Fluidized Catalytic Cracking (FCC) catalyst with a concentration of about 23 to 29%, preferably about 25 to 27% of hydrochloric acid at a temperature of about 90. Degree. C. to about 110. Degree. C. for a period of about 20 to 35 minutes in a weight range of said spent FCC catalyst to the total of said hydrochloric acid of abut 1:1 and a weight rang of said waste iron dust to the total of said spent FCC catalyst of about 1:100 to 5:100. and is then mixed with sodium hydroxide and sodium carbonate to achieve the optimum PH within the range of about 3 to about 4.

2. The method claimed in claim 1 wherein said polymeric aluminum chloride is made from the aluminum providing source, namely, spent FCC catalyst that is synthetic aluminum silicate containing large amount of molecular sieve of about 40% or more and normal content of aluminum oxide of about 40% or above.

3. The method claimed in claim 1 wherein said the weight ratio of said spent FCC catalyst to the total of said hydrochloric acid is about 1:1.

4. The method claimed in claim 1 wherein said the weight ratio of said iron dust to the total of said spent FCC catalyst is about 1:100 to about 5:100.

5. The method claim in claim 1 wherein said acid is hydrochloric acid in concentration of about 23 to 29%, Said temperature is about 90. Degree. C. to about 110. Degree. C.

6. The method claimed in claim 5 wherein said concentration of hydrochloric acid is preferably about 25 to 27%.

7. The method claimed in claim 6 wherein said concentration of hydrochloric acid is about 25%, and said temperature is about 98. Degree. C.

8. The method claimed in claim 1 where said mixed sodium hydroxide and sodium carbonate to achieve the desire optimum PH within the range of about 3 to about 4.

9. A coagulating and flocculating agent consisting essentially of polymeric aluminum chloride (PAC, [Al₂(OH)ₙCl₆₋ₙ]ₘ, n<5, m<10), hydrated ferric chloride ([FeCl₃·6H₂O]) and extracted spent FCC catalyst in which polymeric aluminum chloride and hydrated ferric chloride are evenly distributed inside the inter pores and outside surface of spent FCC catalysts, wherein said aluminum chloride and hydrated ferric chloride are produced by treating spent Fluidized Catalytic Cracking (FCC) catalyst with a concentration of about 23 to 29%, preferably about 25 to 27% of hydrochloric acid at a temperature of about 90. Degree. C. to about 110. Degree. C. for a period of about 20 to 35 minutes in a weight range of said spent FCC catalyst to the total of said hydrochloric acid of abut 1:1 and a weight rang of said waste iron dust to the total of said spent FCC catalyst of about 1: 100 to 5:100. and is then mixed with sodium hydroxide and sodium carbonate to achieve the desire optimum PH within the range of about 3 to about 4.
